(19) United States
(12) Patent Application Publication
(10) Pub. No.: US 2010/0081389 A1
(43) Pub. Date: Apr. 1, 2010

(54) METHOD AND APPARATUS FOR DETERMINING PROPAGATION DELAY

(75) Inventors: Ivan LAWROW, Sheffield (GB); Stephen BATE, Sheffield (GB)

Correspondence Address: WILMERHALE/BOSTON, 60 STATE STREET, BOSTON, MA, 02109, US

(73) Assignee: JENNIC LTD., Sheffield (GB)

(21) Appl. No.: 12/239,322

(22) Filed: Sep. 26, 2008

(51) Int. Cl. H04B 17/00

(52) U.S. Cl. 455/67.11

(57) ABSTRACT

Embodiments of the present invention provide a method of determining a propagation delay of wireless communications between wireless network devices, comprising exchanging first and second messages with a wireless network device; determining first time information based upon the exchange of the first and second messages; receiving second time information from the wireless network device, the second time information based upon the exchange of the first and second messages; and determining a propagation delay based upon the first and second time information.

### FIELD OF THE INVENTION

Embodiments of this invention relate to a method and system for determining a propagation delay of communications.

### BACKGROUND

In a wireless network, nodes communicate with each other. For example, a first node may send information to a second node. In this example, the first node is a source node or transmitter and the second node is destination node or a receiver. However, the first node may also include the capability for receiving and/or the destination node may include the capability for transmitting.

A propagation delay of communications sent between the first and second nodes can be measured using timers located within the respective nodes. However, a clock signal generated by one node that drives the node's timer may include an offset and/or may not be exactly matched in frequency to a clock signal generated by the other node to drive the other node's timer. Therefore, one or both of the timers may measure incorrect times, and errors may thus be introduced into the measure of the propagation delay.

It is an object of embodiments of the invention to at least mitigate one or more of the problems of the prior art.

### BRIEF DESCRIPTION OF THE DRAWINGS

Embodiments of the invention will now be described by way of example only, with reference to the accompanying figures, in which:

FIG. 1 illustrates an example of a wireless network;

FIG. 2 is an illustration of communications sent between two nodes in embodiments of the invention;

FIG. 3 illustrates example timings of the communications shown in FIG. 2;

FIG. 4 illustrates communications sent between two nodes in some embodiments of the invention;

FIG. 5 illustrates example timings of the communications shown in FIG. 4;

FIG. 6 is an illustration of clock and received signal levels and a time period there-between;

FIG. 7 is a further illustration of example timings of the communications shown in FIG. 2 including delta time periods;

FIG. 8 illustrates an example of an apparatus for determining the value of delta;

FIG. 9 illustrates an example of a correlator for determining the value of delta;

FIG. 10 is a graph of example values presented to a peak detector in the correlator of FIG. 9;

FIG. 11 illustrates a further example of a correlator for determining the value of delta;

FIG. 12 illustrates another example of a wireless network; and

FIG. 13 illustrates an example of using trilateration to find a location of a node in a two-dimensional space.

### DETAILED DESCRIPTION OF EMBODIMENTS OF THE INVENTION

Embodiments of the invention provide a method and apparatus for accurately determining a propagation delay between wirelessly communicating nodes. In embodiments of the invention, a mechanism for reducing or eliminating the effect of clock frequency error or clock frequency offset in the two nodes is provided, such that any error in measuring the propagation delay of communications sent between the two nodes can be reduced or eliminated.

Embodiments of the present invention are particularly useful in determining a communication delay between two nodes when one or both of the nodes are mobile nodes. Embodiments of the present invention will be explained with reference to a pair of nodes, one of which is a mobile node and one of which is a fixed node.

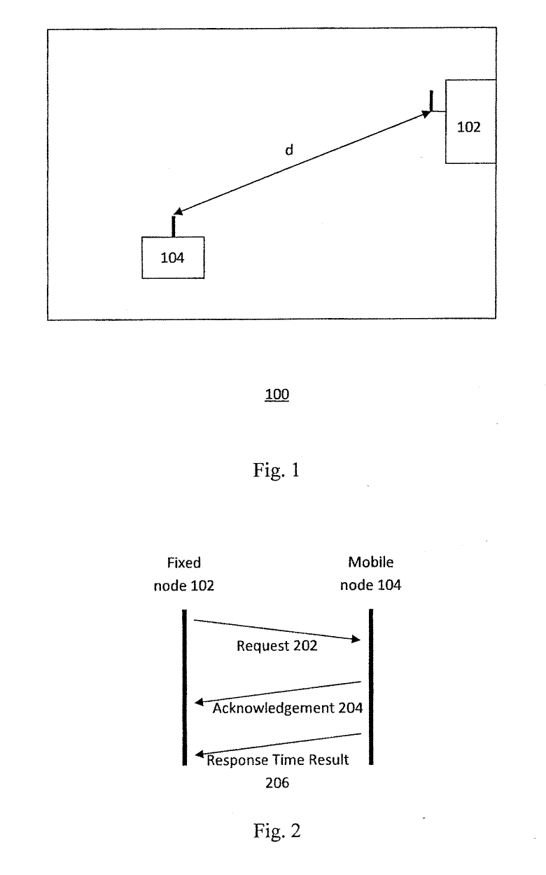

FIG. 1 shows an example of a wireless network 100. The network 100 comprises a fixed node 102 and a mobile node 104. The nodes 102 and 104 are separated by a distance d. Whilst the network may be a wireless network conforming to any standard, in some embodiments the network 100 may be a Zigbee network. The Zigbee specification is based on the IEEE 802.15.4 communication standard. In other embodiments of the invention, the network is another type of IEEE 802.15.4 based network. One of the nodes 102, 104 may represent a coordinator in an IEEE 802.15.4 based network.

The nodes 102 and 104 may represent some or all of the nodes in the network 100 that can transmit communications to other nodes and receive communications from other nodes. The position of the mobile node 104 may change over time, and a propagation delay of communications sent between the mobile node 104 and the fixed node 102 cannot be predetermined or known in advance.

Embodiments of the invention involve independent measurement of time periods and communication of information concerning at least one of those time periods between the nodes such that one of the nodes can accurately determine the propagation delay between the nodes.

FIG. 2 illustrates communications sent between the fixed node 102 and the mobile node 104 in embodiments of the invention.

Firstly, the fixed node 102 sends a Request communication 202 to the mobile node 104. The fixed node 102 then begins to time a duration t_{tA} between sending the Request communication 202 and receiving an Acknowledgement communication 204 from the mobile node 104. In embodiments of the invention, this is accomplished by the fixed node 102 recording a value of a local timer or resetting and starting the local timer upon completion of transmitting the Request communication 202. Communications 202, 204, 206 may comprise one or more packets, although in embodiments of the invention the communications 202, 204, 206 comprise a single packet.

When the mobile node 104 has received the Request communication 202, it sends the Acknowledgement communication 204 to the fixed node 102. According to the 802.15.4 specification, an acknowledgement communication should be sent 192 μs after receipt of an original communication being detected. Therefore, the Acknowledgement communication 204 is sent (that is, transmission of the communication is started) approximately 192 μs after receipt (end of reception) of the Request communication 202. This response time period may be achieved by detecting the receipt of the Request communication 202 on a clock edge and starting transmission of the Acknowledgement communication 204 on another clock edge. However, the response time period may in practice be a time other than 192 μs. Therefore, the mobile node 104 sends a Response Time Result (RTR) communication 206 to the fixed node 102. The RTR communication 206 contains information indicating a value of t_{rB} measured by the mobile node 104 which indicates a period t_{rB} between receipt (end of reception) of the Request communication 202 by the mobile node 104 and completion of transmission of the Acknowledgement communication 204 by the mobile node 104. Therefore, the fixed node 102 obtains information indicating the actual turnaround or response time t_{rB} at the mobile node 104. On receiving the RTR communication 206 the fixed node 102 can calculate a propagation delay t_{pd} as will be explained. In embodiments of the invention t_{pd} is the time taken for a communication from one of the nodes to propagate through the transmission medium (for example, air) to the other node.

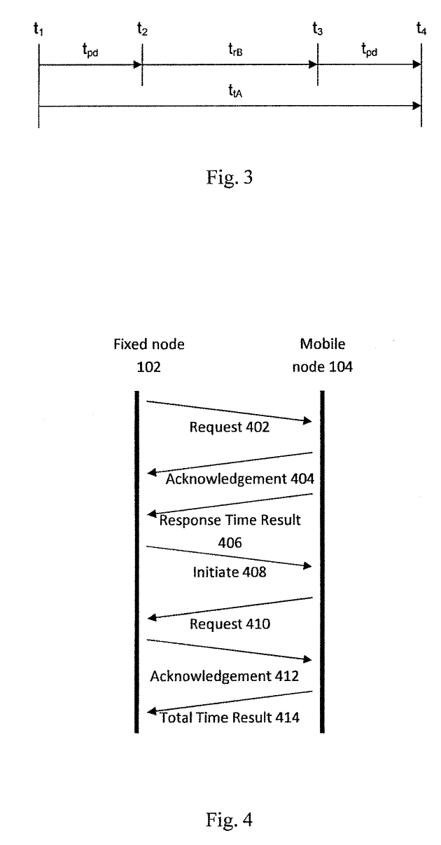

FIG. 3 illustrates time delays within the network 100 of the communications shown in FIG. 2. At time t₁, transmission from the fixed node 102 of the Request communication 202 has completed. At time t₂, after a propagation delay t_{pd}, reception of the Request communication 202 by the mobile node 104 has completed. At time t₃, transmission of the Acknowledgement communication 204 from the mobile node 104 has completed. To illustrate the operation of embodiments of the invention an example duration of t₃ will be described of 544 μs. The 544 μs time period t_{rB} comprises, for example, a turnaround time of 192 μs and a time period of 352 μs between the start and completion of transmission of the Acknowledgement communication 204 by the mobile node 104. In practice, the time period t_{rB} may be a value other than 544 μs depending upon the actual response time of the mobile node 104. At time t₄, following another propagation delay t_{pd}, reception of the Acknowledgement communication 204 at the fixed node 102 has completed. The above assumes that the propagation delay t_{pd} is the same in both directions between the nodes. Once the fixed node 102 has received the RTR communication 206 then the fixed node 102 can calculate the propagation delay t_{pd}. It will be noted that the RTR communication is not shown in FIG. 3.

As noted above, the fixed node 102 measures a time t_{tA} between the times t₁ and t₄ (completion of transmission of Request 202 and receipt of Acknowledgement 204) for example by starting and stopping an internal timer. The fixed node 102 also obtains information indicating the turnaround time t_{rB} between t₂ and t₃ from the RTR communication 206. Therefore, for an ideal case where the clock signals in both nodes 102, 104 are identical at a frequency f_{c}, the propagation delay t_{pd} of Request and Acknowledgment communications 202, 204 can be determined as follows. From FIG. 3 it can be seen that:

t_{tA}=t_{tpd}+t_{rB}+t_{tpd} (1)

### Therefore:

$${t}_{pd} = \frac{( {t}_{tA} - {t}_{rB} )}{2} \qquad ( 2 )$$

However, the clock signals within each of the nodes 102,104 may include a frequency error or offset. For example, the error in the clock frequency of the fixed node 102 is f_{A}, and the error in the clock frequency of the mobile node 104 is f_{B}, where f_{A} and f_{B} are fractions of the ideal clock frequency f_{C}. Therefore, the time t_{tA} as measured by the fixed node 102 is measured as t_{tA}+t_{tA}.f_{A}, and the turnaround time t_{rB} as measured by the mobile node 104 is t_{rB}+t_{rB}.f_{B}. The errors lead to the fixed node 102 calculating an approximate propagation delay t_{pdA} as follows:

$${t}_{pdA} = \frac{( {t}_{tA} + {t}_{tA} {f}_{A} - {t}_{rB} - {t}_{rB} {f}_{B} )}{2} \qquad ( 3 )$$

Thus, an error e_{pdA} is included within the measurement of t_{pdA} by the fixed node 102, where:

$${e}_{pdA} = \frac{( {t}_{tA} {f}_{A} - {t}_{rB} {f}_{B} )}{2} \qquad ( 4 )$$

Substituting Equation 1 into 4 gives:

$${e}_{pdA} = {t}_{pd} {f}_{A} + {t}_{rB} \frac{( {f}_{A} - {f}_{B} )}{2} \qquad ( 5 )$$

Even if the errors in the clock frequencies are small, the error introduced into the measurement of t_{pdA} may be significant if the turnaround time t_{rB} is much larger than the ideal propagation delay t_{pd}. For a communication system where t_{rB} is 544 μs and the nodes are separated by 30 metres or less, for example, then t_{rB} will be much larger than t_{pd}.

FIG. 4 shows an example of communications sent between the fixed node 102 and the mobile node 104 according to further embodiments of the invention. In these further embodiments of the invention, the fixed node 102 is also provided with information relating to a total communication duration as measured by the mobile node 104.

The communications in FIG. 4 comprise Request 402, Acknowledgment 404 and RTR 406 communications identical to those 202-206 shown in FIG. 2. Following receipt of the RTR communication 406 that indicates the turnaround time t_{rB} at the mobile node 104, the fixed node 102 can calculate a propagation delay t_{pdA} as indicated above in equation (3). However, in order to improve an accuracy of the propagation delay measurements, the fixed node 102 initiates further Request and Acknowledgment communications 402-404 in an opposing direction. That is, the direction of communications is reversed between the fixed and mobile nodes 102, 104, as will be explained. The fixed node 102 initiates the further communications by sending an Initiate communication 408 to the mobile node 104. Following receipt of the Initiate communication 408, the mobile node 104 then sends a Request communication 410 to the fixed node 102. The mobile node 104 then begins to time a duration t_{tB} between sending the Request communication 410 and receiving an Acknowledgement communication 412 from the fixed node 102. In embodiments of the invention, this is accomplished by the mobile node 104 recording a value of a local timer or resetting and starting the local timer upon completion of transmitting the Request communication 410. When the fixed node 102 has received the Request communication 410, it sends the Acknowledgement communication 412 to the mobile node 104. Following receipt of the Acknowledgment communication 412 the mobile node 104 sends a Total Time Result (TTR) communication 414 to the fixed node 102. The TTR communication 414 contains information indicating a value of t_{tB} measured by the mobile node 104, i.e. a period t_{tB} between an end of transmitting the Request communication 410 by the mobile node 104 and completion of reception of the Acknowledgement communication 412 by the mobile node 104. Therefore, the fixed node 102 obtains information indicating the total communication time t_{tB} at the mobile node 104 from the TTR communication 414. The fixed node 102 also measures the turnaround or response time t_{rA} at the fixed node 102 between receipt (end of reception) of the Request communication 410 by the fixed node 102 and completion of transmission of the Acknowledgement communication 412 by the fixed node 102.

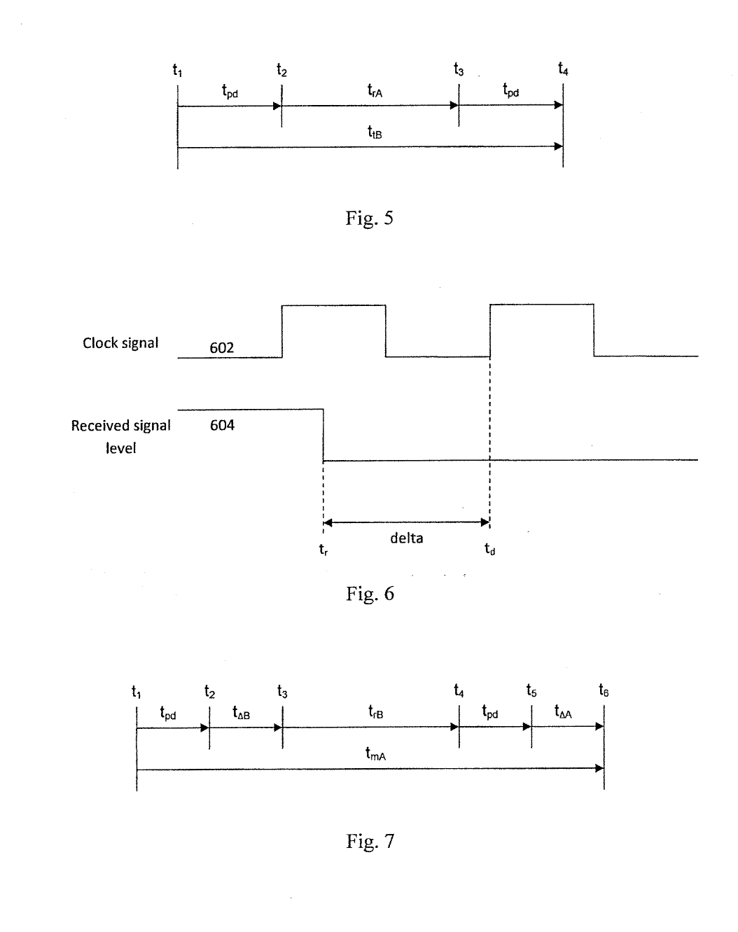

FIG. 5 shows timings of sending the Request communication 410 by the mobile node 104 and receiving the Acknowledgment communication 412 by the mobile node. The events occurring with at timings t1-3 and the time periods there-between will be understood with reference to FIG. 3, bearing in mind the mobile node 104 sending the Request communication 410 and the fixed node 102 the Acknowledgement communication in FIG. 5.

If the local clock reference signals in each of the nodes 102, 104 are ideal, then the propagation delay is:

$${t}_{pd} = \frac{( {t}_{tB} - {t}_{rA} )}{2} \qquad ( 6 )$$

However, due to frequency errors in the local oscillators of each node 102, 104 an error e_{pdB} is present in the propagation delay calculated by the fixed node 102 when the measurement is initiated by the mobile node sending the Request communication 410. The error is given by:

$${e}_{pdB} = {t}_{pd} {f}_{B} - {t}_{rA} \frac{( {f}_{A} - {f}_{B} )}{2} \qquad ( 7 )$$

In embodiments of the present invention, the fixed node 102 calculates a mean propagation delay t_{pdm} using the information obtained from RTR and TTR communications 406, 414. The mean propagation delay t_{pdm} is calculated by determining the mean value of the first propagation delay t_{pd} of Request and Acknowledgment communications 402, 404 and the second propagation delay of Request and Acknowledgement communications 410, 412 t_{pd}. Using this information as well as local timer measurements, then the mean propagation delay error e_{pd} is given by:

$${e}_{pd} = \frac{{t}_{pd} ( {f}_{A} + {f}_{B} )}{2} + \frac{( {t}_{rB} - {t}_{rA} ) ( {f}_{A} - {f}_{B} )}{4} \qquad ( 8 )$$

Since the response times t_{rA}, t_{rB} of each node 102, 104 are likely to be approximately equal; the resultant contribution of the response times to the mean propagation delay error cancels and is thus negligible.

As an example, the following figures are used:
f_{A}=40 parts per million (ppm)
f_{B}=−40 ppm
t_{rB}=544 μs (example value, as explained above)
t_{rB}−t_{rA}=4 μs between the values of t_{rB} and t_{rA} (i.e. worst case differential value For an IEEE 802.15.4 network this is less than one bit-period i.e. 4 μs)
t_{pd}=100 ns (for a 30-metre separation between the nodes 102 and 104)

The measurement of t_{pdA} by the fixed node 102 gives an error of:

$$\begin{matrix}{e}_{pdA} = {t}_{pd} {f}_{A} + {t}_{rB} \frac{( {f}_{A} - {f}_{B} )}{2} & ( 11 ) \\ {e}_{pdA} = 100 {e}^{- 9} \times 40 {e}^{- 6} + 544 {e}^{- 6} \frac{( 40 {e}^{- 6} + 40 {e}^{- 6} )}{2} \\ = 21.764 {e}^{- 9} s & ( 12 )\end{matrix}$$

Since e_{pdA}=21.764 ns and t_{pd}=100 ns, e_{pdA} is a 21.764% error on t_{pd}.

Similarly, the error e_{pdB} can be calculated as e_{pdB}=−21.604 ns which is a −21.604% error on t_{pd}.

Using the mean of the calculated values t_{pdA} and t_{pdB} gives an error of (from equation 8):

$$\begin{matrix}{e}_{pd} = \frac{{t}_{pd} ( {f}_{A} + {f}_{B} )}{2} + \frac{( {t}_{rB} - {t}_{rA} ) ( {f}_{A} - {f}_{B} )}{4} & ( 13 ) \\ {e}_{pd} = \frac{100 {e}^{- 9} ( 40 {e}^{- 6} - 40 {e}^{- 6} )}{2} + \frac{4 {e}^{- 6} ( 40 {e}^{- 6} + 40 {e}^{- 6} )}{4} \\ = 80 {e}^{- 12} s & ( 14 )\end{matrix}$$

Since e_{pd}=80 ps, this is a 0.8% error on t_{pd}. Thus, the mean e_{pd} of the calculated values t_{pdA} and t_{pdB} gives a result for the propagation delay t_{pd} that is more accurate than the propagation delay value calculated a node 102 using only total delay and turnaround time each measured by one node respectively.

Embodiments of the invention may further include determining a “delta” value representing a time period between completion of receiving a communication and detection of receipt of the communication by a node. The determination of the delta value may be used in the above-described methods to further improve an accuracy of propagation delay measurement.

The above described embodiments of the invention assume that receipt of a communication by a node is detected at the exact moment that receipt of the communication is complete. However, the receipt of the communication may be detected later than this moment. For example, the internal clock signal of a node may be used to drive receiver circuitry within the node. Thus, receipt of a communication may only be detected on a rising and/or falling edge of the clock signal. The delay between completion of receipt of a communication and detection of receipt of communication by a node is referred to as “delta”.

FIG. 6 shows an example illustrating delta. A node has an internal clock signal 502. A communication is received by the node over a period of time as shown by a received signal level 604. At a time tᵣ, receipt of the communication at the node is complete. However, the node does not detect that receipt of the communication is complete until the next rising clock edge at a time t_{d}. The difference between times tᵣ and t_{d} is delta. Thus, in this example, delta is a fraction of a clock cycle period.

FIG. 7 shows an example of time delays within the network shown in FIG. 1 experienced by some of the communications shown in FIG. 2 between nodes which experience delta time delays, i.e. do not detect that receipt of a communication is complete until the next appropriate clock edge. At a time t₁, transmission of the Request communication 202 from the fixed node 102 to the mobile node 104 is complete. At a time t₂, receipt of the Request communication 202 at the mobile node 104 is complete. The difference between t₁ and t₂ is the propagation delay t_{pd}. At a time t₃, the mobile node 104 detects receipt of the Request communication 202, for example on a rising clock edge. The difference between t₂ and t₃ is the delta value t_{ΔB} experienced by the mobile node 104. At a time t₄, transmission of the Acknowledgement communication 204 by the mobile node 104 is complete. The difference between t₃ and t₄ is the turnaround time t_{rB}, which may be 544 μs, for example. At a time t₅, after a propagation delay t_{pd}, receipt of the Acknowledgement communication 204 by the fixed node 102 is complete. At a time t₆, the fixed node 102 detects that receipt of the Acknowledgement communication 204 is complete. The difference between t₅ and t₆ is the delta value t_{ΔA} experienced by the fixed node 102. The time t_{mA} between t₁ and t₆ is measured by the fixed node 102, for example using an internal timer.

The timings shown in FIG. 6 are substantially similar to those shown in FIG. 3, except for the presence of the delta values t_{ΔA} and t_{ΔB}. Therefore, the measured time t_{mA} is equivalent to the time t_{tA} in FIG. 3 but with the additional the delta values, as shown:

t_{mA}=t_{tA}+t_{ΔA}+t_{ΔB} (14)

In the communications shown in FIG. 2, the RTR communication 206 indicates the value of t_{rB} including the measured value of t_{ΔB} whilst the fixed node 102 measures t_{tA} including t_{ΔA}. Similarly, in the communications shown in FIG. 4, the TTR communication 414 indicates t_{tB} including t_{ΔB}. Thus the accuracy of t_{pd} calculation is further improved.

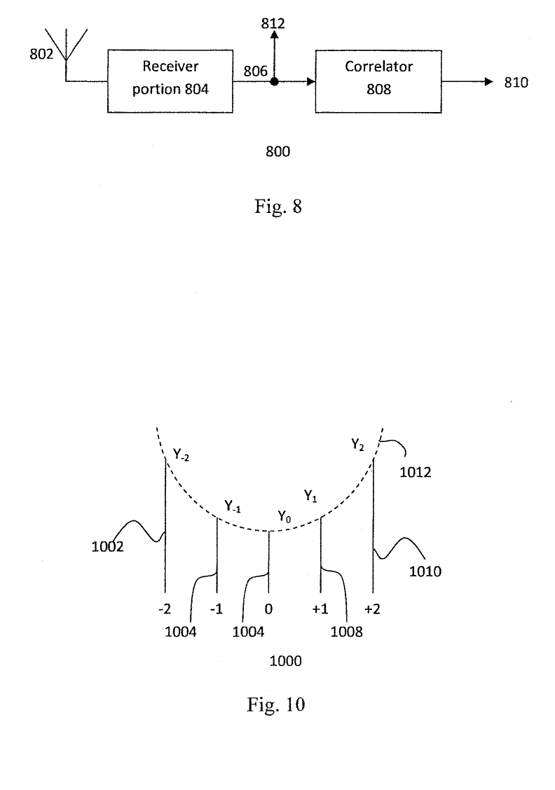

FIG. 8 shows an example of apparatus 800 for determining the value of delta. The apparatus 800 may be contained within a node. The apparatus 800 includes an antenna 802, and a receiver portion 804 for receiving communications from other nodes via the antenna 802. The receiver portion 804 demodulates received communications and provides an output 806 comprising a received bit stream. In embodiments of the invention, for example where the 802.15.4 communication standard is used, a received communication comprises one or more 32-bit sequences, each 32-bit sequence conveying four data bits. The output 806 is provided to a correlator 808 that determines a timing of a received communication, such as, for example, a fraction of a clock cycle between receipt of the communication and first detection of the receipt of the communication.

The correlator 808 provides an output 810 that indicates the fraction of the clock cycle. The apparatus 800 may also provide the output 806 of the receiver portion 804 to other parts of the apparatus (not shown) as indicated by arrow 812.

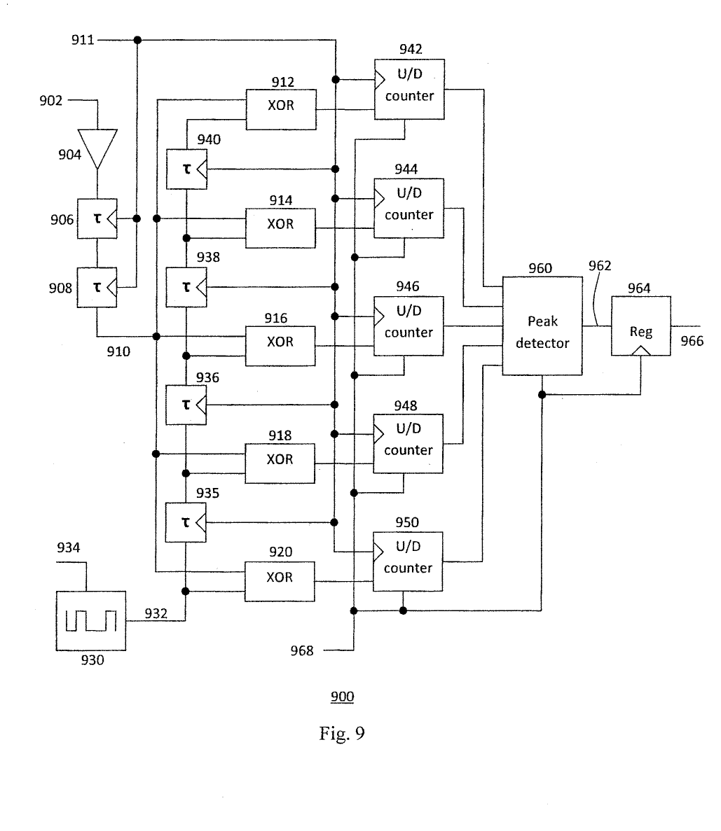

FIG. 9 shows an example of a correlator 900 according to embodiments of the invention. The correlator 900 receives an input 902 which comprises the output 806 of the receiver portion 804 shown in FIG. 8. The input 902 therefore comprises a bit stream. The input signal 902 is provided to a buffer 904 and then to two serially connected delay units 906 and 908, each of which delay the input signal by a delay factor τ. Thus, the output of the second delay unit 908 comprises a signal 910 which is the input signal 902 delayed by 2τ. The delay units 906 and 908 are controlled by a clock signal 911. The signal 910 is provided to one input of each of five XOR logic units 912, 914, 916, 918 and 920 (other embodiments of the invention may include any number of XOR logic units). Each XOR logic unit performs an XOR operation on its two inputs and provides the result as a binary logic output.

A chip sequence generator 930 generates a chip sequence 932 according to a chip sequence phase input 934 to the correlator 900. The chip sequence 932 matches the chip sequence of a received communication. For example, where an 802.15.4 communications standard is used, the chip sequence input 934 is used to control the chip sequence generator 930 such that the chip sequence 932 comprises a 32-bit sequence that matches the 32-bit sequence currently being provided to the correlator 900. That is, the chip sequence 932 matches the bits of the input signal 902 and approximately matches the phase of the input signal 902. The chip sequence 932 is provided to the second input of the XOR logic unit 920 and a delay unit 935. The output of the delay unit 935 is provided to the second input of the XOR logic unit 918 and another delay unit 936. The output of the delay unit 936 is provided to the second input of the XOR logic unit 916 and another delay unit 938. The output of the delay unit 938 is provided to the second input of the XOR logic unit 914 and another delay unit 540. The output of the delay unit 940 is provided to the second input of the XOR logic unit 912. Thus, therefore, the time difference between the input signal as seen by the XOR logic units and the chip sequence as seen by the XOR logic units is +2τ, +τ, 0, −τ and −2τ for the XOR logic units 912, 914, 916, 918 and 920 respectively. That is, for example, the received signal reaches the XOR logic unit 920 −2τ later than the chip sequence signal 932. The delay units 935, 936, 938 and 940 are controlled by the clock signal 911. In embodiments of the invention, the delays τ and 2τ are chosen to be fractions of a clock signal period.

The outputs of the XOR logic units 912, 914, 916, 918 and 920 are provided to up/down counters 942, 944, 946, 948 and 950 respectively. The up/down counters increase or decrease their respective outputs on each pulse from the clock signal 911, according to whether the input from the corresponding XOR logic unit is high or low. For example, in embodiments of the invention, an up/down counter increases its output on a clock pulse when the input is high, and decreases its output if the input is low.

The outputs of the up/down counters 942, 944, 946, 948 and 950 are provided to a peak detector 960. The peak detector 960 determines the timing of the input signal from the outputs of the up/down counters as described in more detail below. An output 962 of the peak detector 960 indicates the timing and is provided to a register 964 that stores the indication or the timing. The output of the register 966 comprises the output of the correlator 900.

The up/down counters can be reset using a reset signal input 968. The reset signal 968 is also used to clock the output 962 of the peak detector 960 into the register 964.

The operation of the correlator will now be described. The phase of the chip sequence 932 is matched approximately to the phase of the input signal 902. For example, the apparatus 800 shown in FIG. 8 may detect a start of frame delimiter (SFD) at the start of a communication being received by the receiver, and uses the SFD to determine the phase of the chip sequence of the incoming communication as is known in the art. The apparatus 800 may include correlation apparatus (not shown) that detects the SFD and/or determines the phase of the chip sequence. The phase of the chip sequence is specified to the correlator 900 via the chip sequence input 934. In embodiments of the invention, the chip sequence input 934 may also be used to specify which chip sequence should be used.

Where an 802.15.4 based communications standard such as Zigbee is used for wireless communications, data contained within a communication is grouped into sets of four bits. A set of four data bits is used to select one of sixteen unique 32-bit sequences defined by the 802.15.4 standard, and the selected 32-bit sequence is transmitted eight times faster than the bit rate of the data bits using an offset quadrature phase shift keying (OQPSK) modulation technique. Thus, the four bit code is transmitted using a spread-spectrum technique. A receiver may identify the 32-bit sequence and thus identify the four data bits being transmitted. A receiver can determine the positions of boundaries between 32-bit sequences by, for example, identifying the start of frame delimiter (SFD) as above, which provides a reference point in time for identifying separate 32-bit sequences.

Therefore, the two signals provided to each of the XOR logic units 912, 914, 916, 918 and 920 are substantially identical, except for a phase delay between the two inputs to each XOR logic unit. For example, if the phase of the input signal 902 and chip sequence signal 934 are exactly aligned in phase, then there is no phase difference between the two signals provided to the XOR logic unit 916, although there is, for example, a +τ delay between the signals provided to the XOR logic unit 914. Similarly, for example, if there is a +τ delay between the phases of the input signal 902 and the chip sequence signal 934, then there is no phase difference between the two signals provided to the XOR logic unit 914, although there is, for example, a +τ delay between the signals provided to the XOR logic unit 912, and a −τ delay between the signals provided to the XOR logic unit 916. The time difference between the signals may comprise a value other than an integer multiple of τ.

If the signals provided to an XOR logic unit are exactly aligned in phase, then the output of the XOR logic unit will always be logic 0 (low). However, a phase difference between the signals provided to an XOR logic unit, even if less than the delay value τ, causes the output of the XOR logic unit to occasionally be logic 1 (high). A greater phase difference causes the output of the XOR logic unit to be high more often and/or for longer periods. Therefore, a greater phase difference causes, over a period of time (the correlation period), an associated up/down counter to count to a higher number.

At the start of the correlation period, a reset signal is sent to the correlator using the reset signal input 968. This causes the up/down counters 942, 944, 946, 948 and 950 to be reset to a predetermined value, for example zero. At the end of the correlation period, which comprises a plurality of clock cycles of the clock signal 911 and may also comprise a plurality of bits of the input signal 902, another reset signal is sent to the correlator, and this causes the peak detector 960 to calculate a peak phase difference value using the inputs from the up/down counters 942, 944, 946, 948 and 950 as indicated in more detail below, and for this value to be stored in the register 964. This also causes the outputs of the up/down counters to be reset to the predetermined value again.

An example of the possible relative values of the outputs of the up/down counters before they are reset are shown in the graph 1000 of FIG. 10. The sizes of the lines 1002, 1004, 1006, 1008 and 1010 correspond to the values Y₋₂, Y₁, Y₀, Y₁ and Y₂ of the outputs of the corresponding XOR logic units 920, 918, 916, 914 and 912 respectively. The values of the outputs form a curve which approximates a quadratic curve 1012. The horizontal axis (x) of the curve 1012 represents a proportion of the value of X between the input signal and the chip sequence signal as seen by each corresponding XOR logic unit 912-920. For example, an x value of −2 indicates a −2τ time difference, which is the time difference seen by the XOR logic unit 912 (or, in alternative embodiments of the invention, the XOR logic unit 912, where a negative time difference indicates that the chip sequence 932 precedes the input signal 902). The vertical axis (y) can be regarded as the number of errors recorded by an XOR logic unit at that delay value. The minimum of the curve 1012 occurs where the delay proportion x approximately matches the time difference between the input signal 902 and the chip sequence signal 932. This value of x may or may not be an integer value and, therefore, the phase difference between the input signal 902 and chip sequence signal 932 may or may not be an integer multiple of τ. Therefore, curve fitting/interpolation is used to determine a value of x where the value of y is at a minimum.

An example of curve fitting, as performed by the peak detector 960, is described below, although other curve fitting/interpolation techniques may additionally or alternatively be used. The lowest three points (i.e. the lowest value and the values either side of the lowest value, where appropriate) are considered for simplicity, and are fitted to the following quadratic equation:

y=Ax²+Bx+C (15)

For the curve shown in FIG. 10, the values Y₋₁, Y₀ and Y₁ are the lowest three values. Three simultaneous equations are formed by inserting these values and their corresponding x values into Equation 15:

Y₋₁=A−B+C (16)

Y₀=C (17)

Y₊₁=A+B+C (18)

Solving Equations 16-18 yields the coefficients of Equation 15:

$$\begin{matrix}B = \frac{1}{2} ( {Y}_{+ 1} - {Y}_{- 1} ) & ( 19 ) \\ A = \frac{1}{2} ( {Y}_{+ 1} + {Y}_{- 1} - 2 {Y}_{0} ) & ( 20 )\end{matrix}$$

Equation 15 can be differentiated to determine the slope of the curve:

$$\frac{d y}{d x} = 2 Ax + B \qquad ( 21 )$$

The minimum of the curve occurs where the slope is zero, i.e.:

$$x = - \frac{B}{2 A} \qquad ( 22 )$$

Using the values of A and B from Equations 21 and 22, x at the minimum can be determined as follows:

$$x = \frac{1}{2} ( \frac{{Y}_{- 1} - {Y}_{+ 1}}{{Y}_{+ 1} + {Y}_{- 1} - 2 {Y}_{0}} ) \qquad ( 23 )$$

The value of x obtained from Equation 23 above can be used to determine the time difference between the input signal 902 and the chip sequence 932 (for example, the time difference is xτ). In embodiments of the invention, this time difference is also delta, the time difference between receipt of the communication and detection of the communication, as the clock signal used to control the chip sequence generator 930 is also the clock signal used to detect incoming communications.

In embodiments of the invention, both the fixed node 102 and the mobile node 104 include apparatus (such as, for example, the apparatus shown in FIG. 8) for determining the value of delta of a received communication. Therefore, the fixed node 102 can determine the value of t_{pdA} as indicated above.

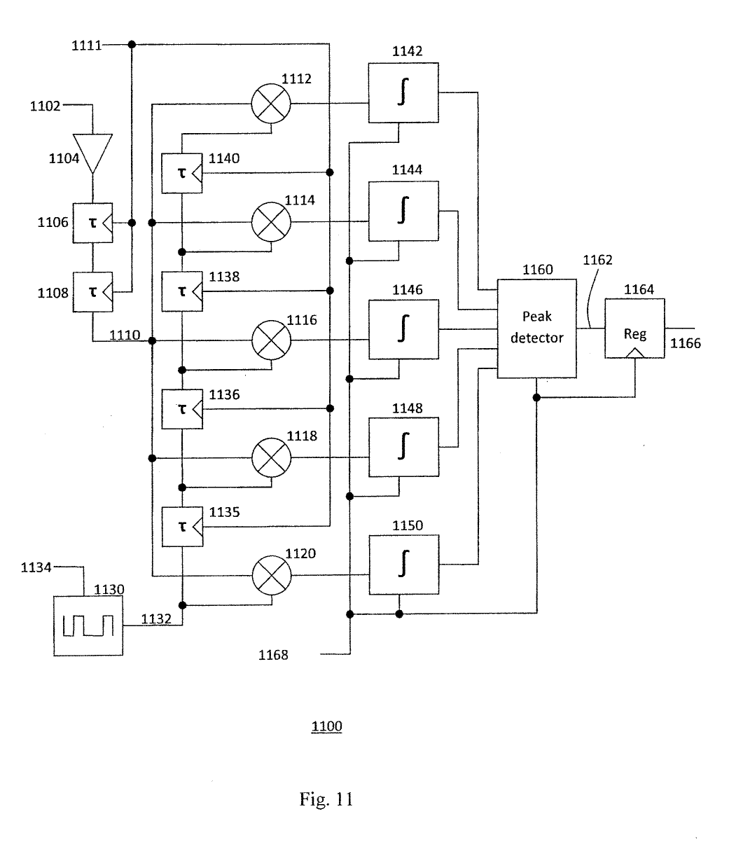

FIG. 11 shows an alternative embodiment of a correlator 1100. The correlator 1100 includes an input 1102 for an input signal which is provided to a buffer 1104. The input 1102 may comprise, for example, the output of the receiver portion 804 shown in FIG. 8. The output of the buffer 1104 is provided to two series connected delay units 1106 and 1108. Each delay unit delays the signal provided to its input by a delay factor τ. Thus, the output 1110 of the delay unit 1108 comprises the input signal 1102 delayed by 2τ. The delay units are controlled by a clock signal 1111. The delayed input signal 1110 is provided to one input of each of five analogue multipliers 1112, 1114, 1116, 1118 and 1120.

A chip sequence generator 1130 generates a chip sequence 1132 according to a chip sequence phase input 1134 to the correlator 1100. The chip sequence 1132 matches a received communication. For example, where an 802.15.4 communications standard is used, the chip sequence phase input 1134 is used to control the chip sequence generator 1130 such that the chip sequence 1132 comprises a 32-bit sequence that matches the 32-bit sequence provided to the correlator 1100 in the input signal 1102. The chip sequence 1132 is provided to the second input of the multiplier 1120 and a delay unit 1135. The output of the delay unit 1135 is provided to the second input of the multiplier 1118 and another delay unit 1136. The output of the delay unit 1136 is provided to the second input of the multiplier 1116 and another delay unit 1138. The output of the delay unit 1138 is provided to the second input of the multiplier 1111 and another delay unit 1140. The output of the delay unit 1140 is provided to the second input of the multiplier 1112. Thus, therefore, the time difference between the received signal as seen by the multipliers and the chip sequence as seen by the multipliers is +2τ, +τ, 0, −τ and −2τ for the multipliers 1112, 1111, 1116, 1118 and 1120 respectively. That is, for example, the received signal reaches the multiplier 1120 −2τ later than the chip sequence signal 1132. The delay units 1135, 1136, 1138 and 1140 are controlled by the clock signal 1111.

The outputs of the multipliers 1112, 1111, 1116, 1118 and 1120 are provided to integrators 1142, 1144, 1146, 1148 and 1150 respectively. The integrators integrate the outputs of the respective multipliers over time. For example, in embodiments of the invention, the bit stream input 1102 comprises a series of bits at voltages +V and −V. Similarly, the chip sequence signal 1132 comprises a series of bits at voltages +V and −V. Thus, the output of each multiplier comprises a positive or negative voltage depending on the inputs to the multiplier.

The outputs of the integrators 1142, 1144, 1146, 1148 and 1150 are provided to a peak detector 1160. The peak detector 1160 determines the timing of a received communication using the outputs of the integrators described in more detail below. An output 1162 of the peak detector 1160 indicates the timing and is provided to a register 1164 that stores the indication or the timing. The output of the register 1166 comprises the output of the correlator 1100.

The integrators 1142, 1144, 1146, 1148 and 1150 can be reset using a reset signal input 1168. The reset signal 1168 is also used to clock the output 1162 of the peak detector 1160 into the register 1164.

The operation of the correlator 1100 is similar to that of the correlator 900 shown in FIG. 9, except that analog components (the multipliers and the integrators) are used to compare the appropriately delayed input and chip sequence signals and to sum the mismatches. Where there is a mismatch between signals provided to a multiplier (for example, one signal is at +V whereas the other is at −V), a negative voltage is output from the multiplier, which causes the associated integrator to reduce its output. Similarly, where there is a match, a positive voltage is output from the multiplier, which causes the associated integrator to increase its output. Therefore, the timing of the received communication can be determined using a method similar to that used in respect of the correlator 900 as indicated above, except that the position (for example, the x-coordinate) of the maximum of the quadratic curve, rather than the minimum, is determined.

The usefulness of embodiments of the invention includes determining a distance between two nodes. For example, the propagation delay t_{pd} may be used to determine a distance that the communication has traveled and, therefore, how far apart the nodes are. The distance to the node may be used in determining a position of the node.

For example, where t_{pd} is 100 ns, the distance d may be calculated by:

d=ct_{Pd}=30 m (24)

where c is a speed of light in air of 299,792,458 ms⁻¹.

The measurement of distance between two nodes may be used to determine the position of one of the nodes relative to the other node. For example, it may be required to know whether a node is within a certain distance from the other node, for example whether the nodes are in the same room. In such a scenario, a measurement of the distance between two nodes may be used to determine whether one of the nodes is far enough away from the other node to be outside of a room in which the receiver is located. Alternatively, for example, a node in a fixed position at one end of an elongate room or space may be used to determine the approximate location of the other node along the length of the room or space. The measurement of distance between the nodes provides a sphere around one of the nodes of the possible positions of the other node and vice versa. If the other node cannot be located in many of the positions (for example, because these positions are located outside of the room or space) then the number of possible positions of the other node may be reduced significantly, and thus the other node may be located or at least information relating to its location has been determined.

In other embodiments, each one of a plurality of nodes may determine the distance between itself and a mobile node, i.e. a node whose location needs to be determined, or the mobile node may determine the plurality of distances between itself and each of the other nodes. The plurality of distances can then be used to determine the location of the mobile node, for example using trilateration as will be appreciated by the skilled person.

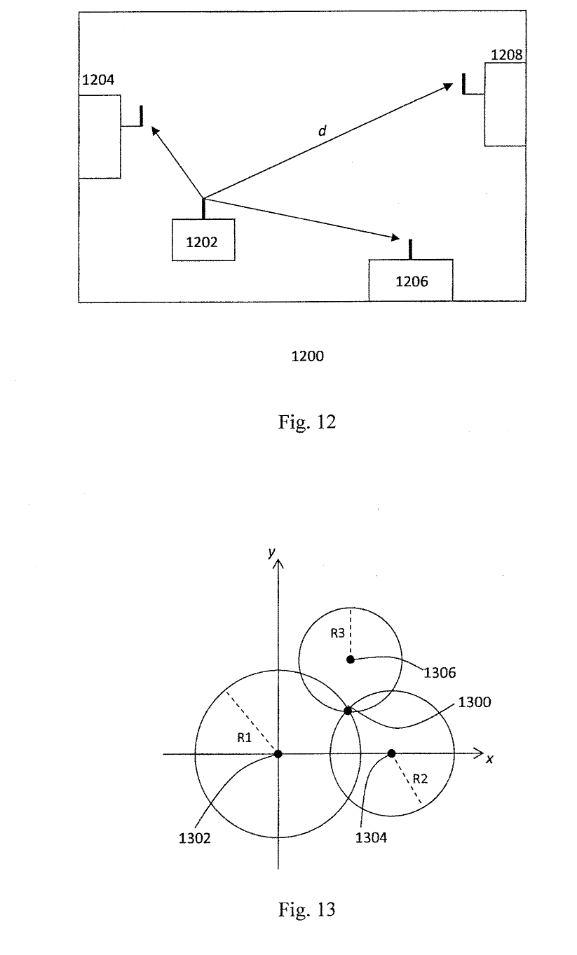

FIG. 12 shows an example of a wireless network 1200 that comprises a mobile node 1202 and three other nodes 1204, 1206 and 1208. The other nodes 1204, 1206 and 1208 may be devices that are fixed in position, and will therefore be referred to hereinafter in this example as fixed nodes. The mobile node 1202 may be a moveable device, i.e. its position may change over time, and hence the position of the node cannot be predetermined. The mobile node 1202 may communicate wirelessly with the fixed devices 1204, 1206, 1208. The fixed devices 1204, 1206 and 1208 may communicate wirelessly with each other, or alternatively some or all of the fixed devices may be connected by a wired network and may communicate with each other using the wired network.

The presence of multiple fixed nodes 1204, 1206, 1208 allows the position of the mobile node 1202 to be determined, using, for example, trilateration. FIG. 13 shows an example of trilateration that can be used to determine the position of a point (for example, the position of a node) in two-dimensional space, although this can be extended to three-dimensional space if desired provided that enough fixed nodes are present and/or the mobile node 1202 cannot be located at certain points. The mobile node 1202 is located at a node point 1300. A first fixed node 1302, a second fixed node 1304 and a third fixed node 1306 determine their distance from the position of the mobile node 1300, for example as described above. Thus, for example, where the first fixed node 1302 determines that its distance from the node point 1300 is R1, then the node point 1300 is a point on a circle of radius R1 centred on the first fixed node 1302. Similarly, the position of the mobile node 1300 is a point on a circle of radius R2 centred on the second fixed node 1304, and is also a point on a circle of radius R3 centred on the third fixed node 1306. Where the position of the mobile node 1300 is a point in three-dimensional space, the node point 1300 is a point on a sphere centred on a receiver instead of a circle.

The location of the first fixed node 1302 is chosen as the origin for a coordinate system for determining the position of the mobile node point 1300, although any other point may be chosen as the origin. The coordinate system is also chosen such that the second fixed node 1304 is located along the x-axis, although the coordinate system can be chosen so that the second fixed node 1304 is not located on the x-axis (for example, the second receiver is located on another axis, or another receiver is located on the x- or y-axis). If the position of the mobile node 1300 is at (x, y) and the location in the coordinate system of the second and third fixed nodes 1304 and 1306 is (a, 0) and (i, j) respectively, then using Pythagoras' theorem gives the following equations:

R1²=x²+y² (25)

R2²=(a−x)²+y² (26)

R3²=(i−x)²+(j−y)² (27)

Subtracting (25) from (26) gives:

R1²−R2²=2ax−a² (28)

Rearranging (28) gives:

$$x = \frac{( R {1}^{2} - R {2}^{2} + {a}^{2} )}{2 a} \qquad ( 29 )$$

Substituting (29) into (27) will give the value for y. Thus, the position (x, y) of the mobile node 1300 can be determined, although other methods of determining the position (x, y) may be used.

In practise, the distances R1, R2 and/or R3 may be inaccurate (i.e. they may contain errors). Therefore, Equations 24 to 26 above may not have a solution. Instead, techniques may be used to determine (x, y) in the presence of errors. For example, optimisation techniques may be employed to determine an estimation of (x, y).

For example, the distance from the mobile node 1202 to a number of fixed nodes 1204, 1206, 1208 may be determined, the number of fixed nodes 1204, 1206, 1208 being greater than the number required for trilateration. A least squares method may then be used to minimise the squared error between the calculated (x, y) and the fixed nodes. For example, e1 is a distance (an error) between (x, y) and the nearest point on a circle of radius R1 centred on a first fixed node. Similarly, e2, e3 and e4 are error distances associated with second, third and fourth fixed nodes respectively. The estimate of (x, y) is chosen such that the sum of the squares of e1, e2, e3 and e4 is a minimum. Other techniques for choosing an estimate for (x, y) may be used, for example which are more robust against data outliers.

The determination of the position of the mobile node 1202 can be determined by any of the nodes in the network. For example, a coordinator may collect indications from one or more fixed nodes and/or the mobile node of the distances between the fixed nodes and the mobile node. The coordinator may then use the indication(s) to determine the position of the mobile node 1202.

Embodiments of the invention as described above refer to fixed nodes in a network. However, in other embodiments of the invention one or more fixed nodes may instead be moveable nodes whose position may change over time. Embodiments of the invention may be used, for example, to determine the position of a moveable node before the distance between the moveable node and the mobile node is determined. Additionally or alternatively, the mobile node may be in a fixed position.

Embodiments of the invention may use the network to convey both position information, such as the location of a mobile node, and other information, such as information transmitted by the mobile node. For example, in a medical application, a mobile node may be used to determine the position of a patient and data associated with the patient if the patient is carrying the mobile node or if the mobile node is fixed to the patient.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A method of determining a propagation delay of wireless communications between wireless network devices, comprising:
exchanging first and second messages with a wireless network device;
determining first time information based upon the exchange of the first and second messages;
receiving second time information from the wireless network device, the second time information based upon the exchange of the first and second messages; and
determining a propagation delay based upon the first and second time information.

2. The method of claim 1, wherein the first time information indicates a time between sending the first message and receiving the second message and the second time information indicates a time between receiving the first message and sending the second message.

3. The method of claim 2, wherein the first and second time information includes a portion of a clock period between the respective events.

4. The method of claim 2, wherein the propagation delay is determined by:
$${t}_{pd} = \frac{( {t}_{tA} - {t}_{rB} )}{2}$$
wherein the first time information is tA, the second time information is tB, and the propagation delay is t_{pd}.

5. The method of claim 1, comprising:
exchanging two further messages with the wireless network device;
determining third time information based upon the exchange of the two further messages;
receiving fourth time information from the wireless network device, the fourth time information based upon the exchange of the two further messages; and
determining a mean propagation delay of the propagation delay of the first and second messages, and a propagation delay of the two further messages based upon the third and fourth time information.

6. The method of claim 5, wherein the third time information indicates a time between receiving a first of the two further messages and transmitting a second of the two further messages and the fourth time information indicates a time between sending the first of the two further message and receiving the second of the two further messages.

7. The method of claim 6, wherein the propagation delay of the two further messages is determined according to the equation:
$${t}_{pd} = \frac{( {t}_{tB} - {t}_{rA} )}{2}$$
wherein the third time information is t_{rA}, the fourth time information is t_{tB}, and the propagation delay of the two further messages is t_{pd}.

8. A wireless network device, comprising:
means for wirelessly exchanging first and second messages with another wireless network device; and
means for determining a first time period based upon the exchange of first and second messages; and
means for determining a propagation delay based upon the first time period and information indicative of a second time period received from the other wireless network device.

9. The wireless network device of claim 8, wherein the means for determining the first time period is arranged to determine the first time period between sending the first message and receiving the second message.

10. The wireless network device of claim 9, wherein the means for determining the first time period is arranged to determine the first time period including a fraction of a clock period.

11. The wireless network device of claim 8, wherein the means for determining the propagation delay is arranged to determine the propagation delay according to:
$${t}_{pd} = \frac{( {t}_{tA} - {t}_{rB} )}{2}$$
wherein the first time information is t_{tA}, the second time information is t_{rB}, and the propagation delay is t_{pd}.

12. The wireless network device of claim 8, comprising:
means for wirelessly exchanging two further messages with the other wireless network device;
means for determining a third time period based upon the exchange of the two further messages; and
means for determining the propagation delay based upon the first time period, the information indicative of the second time period, the third time period and information indicative of a fourth time period received from the other wireless network device.

13. A wireless network, comprising:
a first node arranged to wirelessly exchange first and second communications with a second node;
wherein the first node is arranged to determine first time information based upon the exchange of the first and second communications;
the second node is arranged to determine second time information based upon the first and second communications and to transmit a third communication to the first node containing the second time information; and
the first node is arranged to determine a propagation delay between the first and second nodes according to the first and second time information.

14. The wireless network of claim 13, wherein the first time information indicates a duration between the first node transmitting the first communication and receiving the second communication from the second node and the second time information indicates a duration between the second node receiving the first communication and transmitting the second communication.

15. The wireless network of claim 14, wherein the first node is arranged to determine the first time information including a fraction of a clock cycle between transmitting the first communication and receiving the second communication from the second node.

16. The wireless network of claim 14, wherein the first node is arranged to determine the propagation delay according to the equation:
$${t}_{pd} = \frac{( {t}_{tA} - {t}_{rB} )}{2}$$
wherein the first time information is t_{tA}, the second time information is t_{rB}, and the propagation delay is t_{pd}.

17. The wireless network of claim 13, wherein:
the first and second nodes are arranged to exchange fourth and fifth communications;
the first node is arranged to determine third time information based upon the exchange of the fourth and fifth communications;
the second node is arranged to determine fourth time information based upon the exchange of the fourth and fifth communications and to transmit a sixth communication to the first node containing the fourth time information;
the first node is arranged to determine a mean propagation delay based upon the first, second, third and fourth time information.

18. The wireless network of claim 17, wherein the third time information indicates a time between the first node receiving the fourth communication and transmitting the fifth communication and the fourth time information indicates a time between the second node transmitting the fourth communication and receiving the fifth communication.

19. The wireless network of claim 18, wherein the first node is arranged to determine a propagation delay of the fourth and fifth communications according to the equation:
$${t}_{pd} = \frac{( {t}_{tB} - {t}_{rA} )}{2}$$
wherein the third time information is t_{rA}, the fourth time information is t_{tB}, and the propagation delay is t_{pd}.

20. The wireless network of claim 13, wherein the second node is a mobile node and the first node is arranged to determine a distance to the mobile node according to the propagation delay.
